(19) United States
(12) Patent Application Publication
(10) Pub. No.: US 2026/0365552 A1
(43) Pub. Date: Nov. 19, 2026

(54) APPARATUS FOR PRODUCING MICRO-BUBBLED WATER, AND WATER TREATMENT APPARATUS USING SAME

(71) Applicant: Yu Jin YANG, Ulsan (KR)

(72) Inventor: Yu Jin YANG, Ulsan (KR)

(21) Appl. No.: 19/480,804

(22) PCT Filed: May 3, 2023
(86) PCT No.: PCT/KR2023/006080

§ 371 Date: Nov. 1, 2025

(51) Int. Cl. C02F 1/74

(52) U.S. Cl. CPC C02F 1/74; C02F 2201/002; C02F 2209/38

(57) ABSTRACT

The present invention relates to an apparatus for producing fine-bubbled water, which has two pumps arranged in series and a gas supply pipe arranged therebetween. The present invention relates to a wet oxidation reaction apparatus comprising: a reaction vessel having a reaction space of which the cross-section is circular; a raw-water supply means for supplying raw water containing a reductive substance to the reaction space; a bubbled-water supply unit for mixing water and gaseous oxygen to produce bubbled water and biasingly supplying the bubbled water that has been produced to the reaction space so as to generate a swirling flow in the reaction space; an exhaust unit for discharging gas generated by the reaction between the reductive substance and gaseous oxygen in the reaction space; a drainage unit for discharging water that has undergone the reaction process; and a return unit for drawing water out from the reaction space and transferring the drawn water to the bubbled-water supply unit for circulation.

### TECHNICAL FIELD

Embodiments of the present disclosure relate to a device for generating fine-bubble water for water treatment and a water treatment apparatus (e.g., a wet oxidation reaction apparatus or a flotation separation apparatus) using the same.

### BACKGROUND ART

In general, raw water (water to be treated) containing various reducing substances, including organic materials, is treated through a method using one of biological treatment, incineration, evaporation concentration, membrane filtration, and wet oxidation or through a method using combinations thereof.

In this case, wet oxidation is a process that converts oxidizable components in water into low-molecular-weight substances having high biodegradability, such as acetic acid and formic acid, or decomposes the oxidizable components into harmless substances, such as water, carbon dioxide, and sulfates, through reaction with oxidizing agents including hydrogen peroxide, oxygen, or chlorine dioxide. Such wet oxidation technology was developed by H. J. H. Fenton in the 1890s and by Fred T. Zimmerman in the 1940s, and may be applied in various ways within a temperature range from room temperature to 374 °C, which is the critical temperature of water, depending on the reactivity of reducing substances, the type of oxidizing agent used, whether a catalyst is applied, and the type of catalyst. In general, as the reaction temperature increases, the reactivity improves. However, the pressure in the reaction system also increases, thereby increasing the manufacturing cost of equipment and making it difficult to maintain stable operating conditions. Therefore, wet oxidation is performed under temperature conditions in a range of 120 °C to 320 °C. The main treatment targets include alkaline wastewater generated during the removal of acidic substances (such as phenols and sulfur compounds) produced in refining and petrochemical processes, refractory industrial wastewater such as dyeing wastewater, and wastewater such as organic waste sludge that is difficult to treat biologically and has low calorific value, thereby incurring high costs when incinerated.

In performing water treatment through wet oxidation, when gaseous oxygen (air in a gaseous state or a gas containing concentrated oxygen) is used as an oxidizing agent, it is difficult to cause the reducing components dissolved in water to react with the gaseous oxygen, because the oxidizing power of oxygen is relatively weak compared to chlorine or ozone and the solubility of oxygen in water is low. Under the same temperature and pressure conditions, in order to supply gaseous oxygen into water at a faster rate and to improve dissolution efficiency, it is necessary to maximize the contact area between water and gaseous oxygen and to increase the residence time of the gaseous oxygen in the water.

However, in the wet oxidation reaction apparatus according to the related art, although gaseous oxygen is dispersed into water in the form of bubbles, the gaseous oxygen is merely supplied to a lower portion of the reaction vessel. As a result, the generated bubbles form a high-velocity upward water flow together with the surrounding water and pass through the reaction vessel, thereby shortening the residence time of the bubbles, reducing oxygen transfer efficiency, and increasing oxygen loss. This will be described in more detail with reference to FIG. 9.

As shown in FIG. 9, the wet oxidation reaction apparatus according to the related art mixes gaseous oxygen with raw water containing reducing substances using a mixing unit 167 to generate bubble water in which bubbles are distributed, and supplies the generated bubble water to a lower portion of a reaction space 162 in a reaction vessel 161 via a distribution head 166. The bubble water is continuously supplied to the lower portion of the reaction space 162. In the reaction space 162, the bubbles 165 form an upward water flow together with the surrounding water in a vertical direction, rapidly reach an upper portion of the reaction space 162, and are then discharged from the reaction space 162 through a discharge pipe 163 and a pressure control unit 164 provided on the discharge pipe 163.

As described above, in the wet oxidation reaction apparatus according to the related art, the bubbles 165 supplied to the lower portion of the reaction space 162 move along a short path while forming an upward water flow until the bubbles 165 reach the discharge pipe 163 positioned at the upper portion, resulting in a relatively short residence time of the bubbles 165 within the reaction space 162. Consequently, the gaseous oxygen supplied to the reaction space 162 does not sufficiently participate in the reaction, leading to significant loss of the gaseous oxygen. Although the gaseous oxygen is air that is freely available, such loss of the gaseous oxygen increases the operating costs of the apparatus because energy is consumed to compress the gaseous oxygen and the gaseous oxygen is heated to a temperature required for the reaction and is finally discharged while containing a certain amount of water vapor, thereby causing energy loss in the reaction system. For reference, in the wet oxidation reaction apparatus according to the related art, reactants such as raw water and gaseous oxygen introduced into the reaction vessel 161 generally pass through a predetermined heating unit in advance; however, illustration of the heating unit is omitted in FIG. 9.

In addition, when supplying a gas such as air to a water treatment apparatus, including the wet oxidation reaction apparatus described above, supplying the gas in the form of microbubbles is advantageous for increasing the contact area between the gas and water and for extending the residence time of the supplied bubbles in the water. Therefore, a device capable of supplying a large amount of microbubbles into water is also very important.

As an example of the related art for supplying microbubbles into water for water treatment, there is a method in which water and air are supplied together to an electric centrifugal pump, also referred to as a friction pump, and bubbles are dispersed into the water by the rotational power of an impeller inside the electric pump and then discharged outside the pump. In this case, when the amount of air supplied to the pump increases, air accumulates around the central shaft portion inside the casing of the pump, causing the impeller of the pump to rotate without pumping water, which results in cavitation. This imposes a limitation on the amount of air supplied.

Related patent documents include U.S. Pat. No. 5,614,087 (Mar. 25, 1997), Korean Patent Laid-Open Publication No. 10-2017-0002455 (Jan. 6, 2017) , and Korean Patent Registration No. 10-1209463 (Dec. 7, 2012).

### DISCLOSURE

### Technical Problem

Embodiments of the present disclosure are directed to providing a fine-bubble water generating device (or fine bubble water generating device) capable of stably generating fine-bubble water by preventing the occurrence of cavitation inside an electric pump when generating a large amount of fine-bubble water using the electric pump for water treatment. In addition, embodiments of the present disclosure are directed to providing a water treatment apparatus using the fine-bubble water generating device.

Embodiments of the present disclosure relate to a wet oxidation reaction apparatus using gaseous oxygen such as air in order to treat raw water containing reducing substances. Embodiments of the present disclosure are directed to solving a problem in which bubbles of gaseous oxygen supplied to a lower portion of a reaction space immediately rise in a vertical direction, rapidly reach an upper portion of the reaction space, and are discharged outside the reaction space, so that the gaseous oxygen does not sufficiently participate in an oxidation reaction with the raw water.

An aspect of embodiments of the present disclosure is to provide a wet oxidation reaction apparatus configured such that bubbles of gaseous oxygen rise while swirling in a state of being mixed with raw water in a reaction space, thereby allowing the bubbles to remain in the reaction space for a longer period of time.

Another aspect of embodiments of the present disclosure is to provide a wet oxidation reaction apparatus configured to circulate treated water obtained through an oxidation reaction back into the reaction space while mixing the treated water with gaseous oxygen, thereby supplying a larger amount of gaseous oxygen to the reaction space.

The aspects of the present disclosure are not limited to those mentioned above, and other aspects not mentioned herein will be clearly understood by those skilled in the art from the following description.

### Technical Solution

According to an embodiment of the present disclosure, there may be provided a device for generating a large amount of fine-bubble water (micro-bubble water) in which two upstream and downstream electric pumps are consecutively mounted on a single pipe (first pipe), a gas supply pipe (second pipe) is mounted between the two electric pumps on the above pipe, the two electric pumps are controlled to operate simultaneously, and gas such as air is supplied to the gas supply pipe between the two electric pumps. Accordingly, water in the upstream electric pump, through which only water flows, is forcibly supplied to the downstream electric pump, into which gas is introduced together with the water, thereby preventing the occurrence of cavitation due to accumulation of gas in the downstream electric pump. As a result, bubble water may be generated in a stable state. In addition, in the fine-bubble water generating device according to the embodiment of the present disclosure, the downstream electric pump may be configured such that an impeller inside the pump serves to break gas in water into fine bubbles using strong rotational force generated by an electric motor.

For example, the pipe (first pipe) may include a water inlet pipe disposed at an upstream section of the pipe to receive water and a bubble water supply pipe disposed at a downstream section of the pipe and connected to the water inlet pipe. In addition, the upstream electric pump may be disposed on the water inlet pipe, and the downstream electric pump may be disposed on the bubble water supply pipe.

The fine-bubble water generating device for water treatment according to the embodiment of the present disclosure may further include a flow rate control unit provided on the gas supply pipe.

According to an embodiment of the present disclosure, there may be provided a wet oxidation reaction apparatus including a reaction vessel extending vertically and having a reaction space defined therein so as to have a circular cross-section, a raw water supply unit configured to supply raw water containing a reducing substance to the reaction space, a bubble water supply unit configured to mix water with gaseous oxygen (gas containing concentrated gaseous air or oxygen) to generate bubble water and to supply the generated bubble water to the reaction space in a direction that deviates from a central axis of the reaction space to generate a swirling flow about the central axis within the reaction space, an exhaust unit configured to discharge gas generated during reaction between water of the bubble water and gaseous oxygen and excess gaseous oxygen remaining unreacted in the reaction space in an upward direction, a drain unit configured to discharge water having undergone the reaction downward, and a return unit configured to withdraw water from the reaction space and to transfer the withdrawn water back to the bubble water supply unit.

The bubble water supply unit may include a bubble water supply pipe. In addition, the bubble water supply unit may further include a raw water supply pipe and an oxidizing agent supply pipe. The bubble water supply pipe may have an outlet connected to the periphery of the reaction space in a direction that deviates from the central axis. The bubble water supply pipe may be disposed such that the center of the outlet thereof is positioned at a height within a range of 1% to 25% of the overall height of the reaction space. The raw water supply pipe may be connected to the raw water supply unit including an electric pump. The raw water supply pipe and the oxidizing agent supply pipe may be connected to the bubble water supply pipe to supply raw water containing a reducing substance and a gaseous oxidizing agent including gaseous oxygen to the bubble water supply pipe. Because water (raw water containing a reducing substance) from the raw water supply pipe, water withdrawn from the reaction space by the return unit, and gaseous oxygen from the oxidizing agent supply pipe join and mix with each other in the bubble water supply pipe, the bubble water may be generated in the bubble water supply unit. However, the water from the raw water supply pipe may be injected into the reaction space through a supply path other than the bubble water supply unit.

The exhaust unit may include an exhaust pipe having an inlet connected to an upper end of the reaction space and an exhaust flow controller configured to control an amount of gas discharged through the exhaust pipe after being generated during the reaction. Because the exhaust flow controller adjusts the exhaust flow through the exhaust pipe, the pressure in the reaction space may be maintained at an optimal level required for the oxidation reaction.

The drain unit may include a drain pipe, and the upper end of the drain pipe may be connected to the center of the lower end of the reaction space. Accordingly, the upper end of the drain pipe may be disposed on the central axis, and the drain pipe may provide a lower discharge port (see reference numeral 18 in FIG. 1) in the reaction vessel. The drain unit may further include a drain flow controller configured to control an amount of water discharged through the drain pipe. Because the drain flow controller adjusts the drain flow through the drain pipe, the water level in the reaction space may be maintained at an optimal height required for the oxidation reaction.

The drain pipe of the drain unit may have an extended drain pipe elongated upward such that the drain port serving as an upper end of the extended drain pipe is positioned at a preset height along the central axis of the reaction space, and water may be discharged through the drain port located at the upper end of the extended drain pipe. The preset height may be in the range of 70% to 90% of the overall height of the reaction space.

The wet oxidation reaction apparatus according to the embodiment of the present disclosure may further include a rotation suppressing element provided inside the extended drain pipe to suppress swirling of the water introduced into the extended drain pipe. The rotation suppressing element may suppress the water introduced into the extended drain pipe from swirling within the extended drain pipe, thereby preventing the pressure in the extended drain pipe from being reduced due to centrifugal force generated by the swirling motion of the water. For example, the rotation suppressing element may be a baffle.

The return unit may include a circulation water transfer pipe branching from the drain pipe to return water discharged through the lower discharge port to the bubble water supply unit.

Alternatively, the return unit may include a circulation water discharge pipe disposed outside the drain pipe to form a double-pipe configuration with the drain pipe and connected to the lower end of the reaction space so as to be concentric with the drain pipe and a circulation water transfer pipe connected to the periphery of the circulation water discharge pipe to return water introduced from the circulation water discharge pipe to the bubble water supply unit.

Accordingly, because the circulation water transfer pipe branches from the drain pipe or branches from the circulation water discharge pipe, the circulation water transfer pipe may be connected to the reaction vessel at a position lower than the bubble water supply pipe.

The circulation water transfer pipe may be connected to the bubble water supply pipe. Accordingly, water from the reaction space may be transferred to the bubble water supply pipe via the circulation water transfer pipe. As a result, the bubble water supply pipe and the circulation water transfer pipe connected to each other may provide a circulation path along which the water from the reaction space flows back (returns) to the reaction space.

The wet oxidation reaction apparatus according to the embodiment of the present disclosure may further include a mixing unit configured to forcibly mix water from the raw water supply pipe, gaseous oxygen from the oxidizing agent supply pipe, and water from the circulation water transfer pipe in the bubble water supply pipe. In this case, the mixing unit may include a pump configured to perform a mixing operation and a pumping operation using a rotary blade.

The technical solution will be made more specific and clear through the embodiments and the drawings to be described below. In addition, various technical solutions other than the technical solution mentioned above may be additionally provided below.

### Advantageous Effects

According to the embodiment of the present disclosure, when gas is injected into an intermediate portion between two electric pumps consecutively disposed upstream and downstream, forced water injection by the upstream pump may prevent cavitation in the downstream pump, thereby achieving stable operation of a fine-bubble water generating device. In addition, the two pumps disposed in sequence cooperate to increase pressure of a discharge unit and flow rate, thereby enabling fluid to be injected into a relatively high-pressure vessel and facilitating the generation of a large amount of fine-bubble water.

According to the embodiment of the present disclosure, because gaseous oxygen rises while forming a swirling flow and then descends in a reaction space (having a circular cross-section) in a reaction vessel in the state of being dispersed in water (in a bubble state), the residence time of the bubbles in the reaction space may be increased. In addition, in a subsequent process, a portion of water (treated water) discharged from the reaction vessel after an oxidation reaction (reaction between a reducing substance contained in the water and gaseous oxygen injected into the water) is circulated back to the reaction space, thereby enabling the supply of a larger amount of gaseous oxygen to the reaction space. Therefore, the oxidation reaction process may be performed more economically, and water treatment performance resulting from the process may be greatly improved.

The effects of the present disclosure are not limited to those mentioned above, and other effects not mentioned herein will be clearly understood by those skilled in the art from this specification and the accompanying drawings.

### DESCRIPTION OF DRAWINGS

FIG. 1 is a conceptual view showing the configuration of a fine-bubble water generating device according to an embodiment of the present disclosure.

FIG. 2 is a conceptual view showing the configuration of a wet oxidation reaction apparatus according to a first embodiment of the present disclosure.

FIG. 3 is a conceptual view showing the operation of the wet oxidation reaction apparatus according to the first embodiment of the present disclosure.

FIGS. 4 and 5 are cross-sectional views taken along line A-A in FIG. 3, wherein FIG. 4 shows an example of a connection structure of a bubble water supply pipe, and FIG. 5 shows another example of the connection structure of the bubble water supply pipe.

FIG. 6 is a conceptual view showing the configuration and operation of a wet oxidation reaction apparatus according to a second embodiment of the present disclosure.

FIG. 7 is a process diagram showing an example of a facility including the wet oxidation reaction apparatus according to the embodiment of the present disclosure.

FIG. 8 is a process diagram showing another example of the facility including the wet oxidation reaction apparatus according to the embodiment of the present disclosure.

FIG. 9 is a conceptual view showing the configuration and operation of a wet oxidation reaction apparatus according to a related art.

### BEST MODE

Hereinafter, embodiments of the present disclosure will be described with reference to the accompanying drawings.

A fine-bubble water (micro-bubble water) generating device according to an embodiment of the present disclosure may generate and supply fine-bubble water and may be applied to the field of water treatment in various ways. In one example, the fine-bubble water generating device according to the embodiment of the present disclosure may be used as a gaseous oxygen supply device of a wet oxidation reaction apparatus. In another example, the fine-bubble water generating device according to the embodiment of the present disclosure may be used as a bubble supply device of a flotation separation apparatus.

In this case, the wet oxidation reaction apparatus may be used to cause reducing substances contained in raw water, which is to be treated, to react with an oxidizing agent containing gaseous oxygen for water treatment. For example, the wet oxidation reaction apparatus may be used to convert reducing substances in the raw water, such as organic materials, mercaptide, and sodium sulfide (Na₂S), into harmless oxidized substances such as water, carbon dioxide, and sulfate ions through reaction with gaseous oxygen.

In addition, the flotation separation apparatus may remove suspended substances dispersed in raw water within a flotation separation tank, which is formed in a rectangular or cylindrical shape, by supplying fine-bubble water to the flotation separation tank. The flotation separation apparatus may include a unit for supplying raw water to the flotation separation tank and a unit for removing scum floating on a water surface due to bubbles.

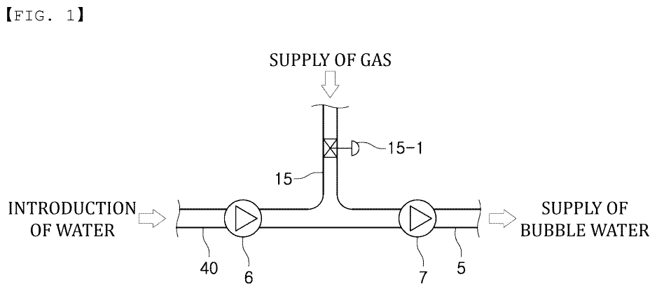

The configuration of the fine-bubble water generating device according to the embodiment of the present disclosure is shown in FIG. 1. The fine-bubble water generating device according to the embodiment of the present disclosure may provide water having a large number of microbubbles dispersed therein.

Referring to FIG. 1, the fine-bubble water generating device according to the embodiment of the present disclosure may include a first pipe, which includes a water inlet pipe 40 through which water for generating bubble water is introduced and a bubble water supply pipe 5 connected to the water inlet pipe 40. In addition, the fine-bubble water generating device according to the embodiment of the present disclosure may further include a second pipe, that is, a gas supply pipe 15, configured to supply gas for generating bubble water to the first pipe and two pumps 6 and 7 provided on the first pipe.

In the first pipe, the water inlet pipe 40 may be disposed upstream of the bubble water supply pipe 5, and the bubble water supply pipe 5 may be disposed downstream of the water inlet pipe 40. The water inlet pipe 40 and the bubble water supply pipe 5 may be directly connected to each other or may be connected to each other via another pipe such as a connection pipe.

The gas supply pipe (second pipe) 15 may be connected to the first pipe between the water inlet pipe 40 and the bubble water supply pipe 5 to supply gas to the first pipe. A gas flow rate control unit (flow controller) 15-1 may be provided on the gas supply pipe 15 to control the flow rate of gas supplied to the first pipe through the gas supply pipe 15.

Among the two pumps 6 and 7, one may be an upstream pump 6 disposed upstream of the connection point between the first pipe and the gas supply pipe 15, and the other may be a downstream pump 7 disposed downstream of the connection point between the first pipe and the gas supply pipe 15. Each of the upstream pump 6 and the downstream pump 7 may be a type of centrifugal pump and may be driven by electric power or pneumatic pressure. It is advantageous that the downstream pump 7 have a larger discharge capacity than the upstream pump 6.

The gas flow rate control unit 15-1 may include a pneumatic automatic control valve. In this case, the gas flow rate control unit 15-1 may be configured to automatically control the gas supply flow rate in conjunction with the flow rate of water supplied to the upstream pump 6. During operation of the fine-bubble water generating device, the upstream pump 6 and the downstream pump 7 may operate simultaneously, and at the same time, a predetermined gas such as air or oxygen may be supplied through the gas supply pipe 15. The gas supplied through the gas supply pipe 15 may be in a pressurized state or may be supplied by a so-called self-suction principle resulting from a pressure reduction in the pipeline due to a difference in discharge capacity between the upstream pump 6 and the downstream pump 7. Fine-bubble water may be generated through water inflow, gas supply, operation of the upstream pump 6, and operation of the downstream pump 7 in the above configuration.

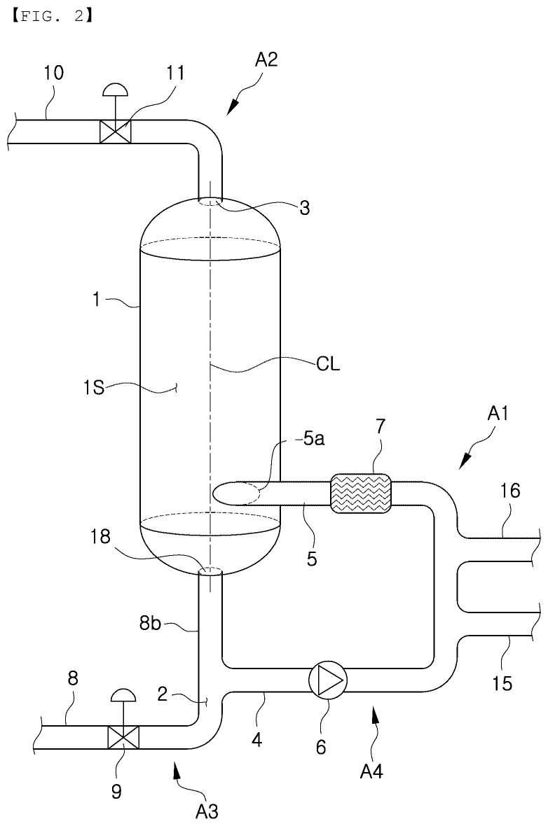

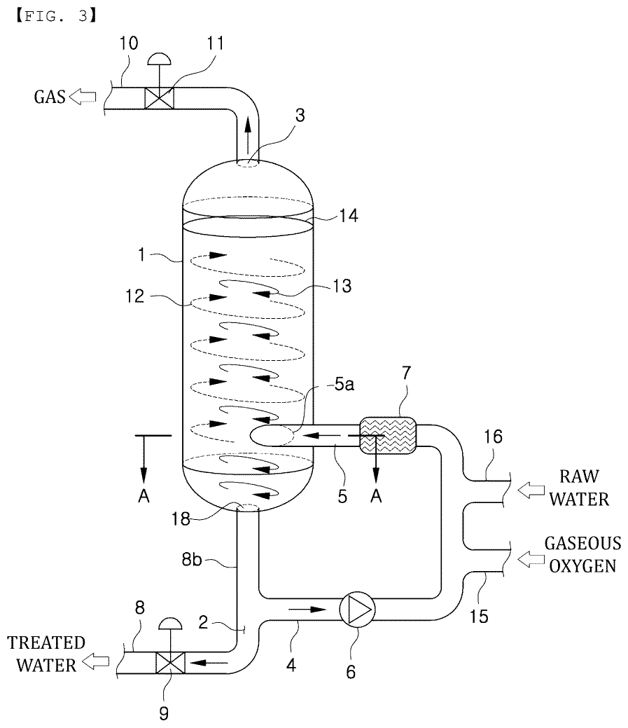

The configuration and operation of a wet oxidation reaction apparatus according to a first embodiment of the present disclosure are conceptually shown in perspective views in FIGS. 2 and 3.

Referring to FIGS. 2 and 3, the wet oxidation reaction apparatus according to the first embodiment of the present disclosure includes a reaction vessel 1 having a reaction space 1S defined therein, a bubble water supply unit A1 configured to supply bubble water in which raw water containing a reducing substance and an oxidizing agent including gaseous oxygen are mixed to the reaction space 1S, an exhaust unit A2 configured to discharge gas generated during a reaction process between the raw water (reducing substance) and the oxidizing agent (gaseous oxygen) from the reaction space 1S, a drain unit A3 configured to discharge treated water having undergone the reaction process from the reaction space 1S, and a return unit A4 configured to transfer a portion of the discharged treated water to the bubble water supply unit A1 from the reaction space 1S.

The reaction vessel 1 extends vertically and is formed such that the reaction space 1S defined therein has a circular cross-section. The reaction vessel 1 includes an exhaust port 3 formed at an upper end thereof so as to communicate with the reaction space 1S and a lower discharge port 18 formed at a lower end thereof so as to communicate with the reaction space 1S. The lower discharge port 18 is disposed at the center of the lower end of the reaction vessel 1 so as to be positioned on a central axis CL of the reaction space 1S.

The bubble water supply unit A1 is configured to supply bubble water to the reaction space 1S in a direction that deviates from the central axis CL of the reaction space 1S, thereby generating a swirling flow of the supplied bubble water within the circular reaction space 1S. The bubble water supply unit A1 includes a bubble water supply pipe 5. The outlet of the bubble water supply pipe 5, through which the bubble water is discharged, is connected to the periphery of the reaction space 1S so as to deviate from the central axis CL of the reaction space 1S. The reaction vessel 1 includes a bubble water inlet 5a formed on the periphery thereof so as to communicate with the reaction space 1S, and the bubble water supply pipe 5 is connected to the bubble water inlet 5a.

The bubble water inlet 5a may be positioned at the lowest possible height on the periphery of the reaction space 1S. This may increase the residence time of bubbles in the reaction space IS, which is advantageous for improving the efficiency of the water treatment process using oxidation reaction. Accordingly, the bubble water inlet 5a may be disposed such that the center thereof is positioned at a height within a range of 1% to 50% of the overall height of the reaction space 1S. Considering process efficiency, it is advantageous that the height be within a range of 1% to 25% of the overall height.

The bubble water supply unit A1 further includes a raw water supply pipe 16 and a gas supply pipe 15, which are connected to the bubble water supply pipe 5, so that bubble water in which raw water (containing a reducing substance) from the raw water supply pipe 16 and an oxidizing agent (including gaseous oxygen) from the gas supply pipe 15 are mixed is generated in the bubble water supply pipe 5, and the generated bubble water is supplied to the reaction space 1S.

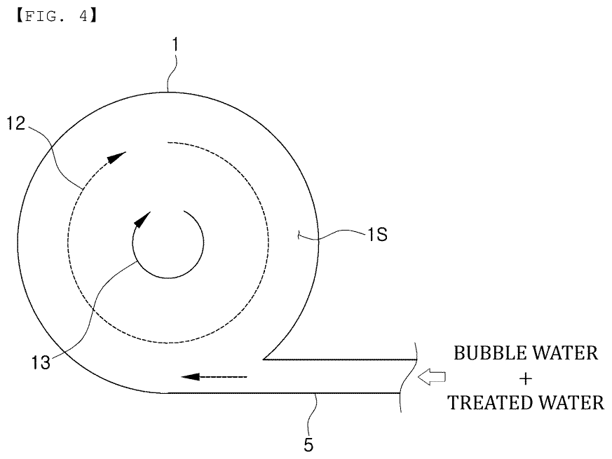

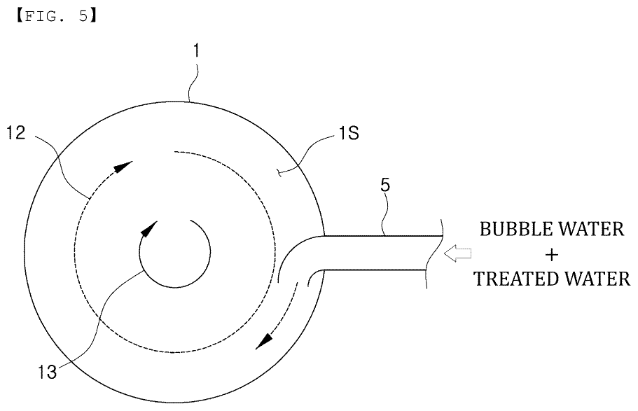

FIGS. 4 and 5 are cross-sectional views taken along line A-A in FIG. 3. As shown in FIG. 4, the outlet of the bubble water supply pipe 5 is connected tangentially to the periphery of the reaction space 1S, thereby supplying bubble water to the reaction space 1S in a direction that deviates from the central axis CL of the reaction space 1S. Alternatively, as shown in FIG. 5, the outlet of the bubble water supply pipe 5 is introduced into and connected to the reaction space 1S through the periphery of the reaction space 1S and is bent toward the inner wall of the reaction space 1S, thereby supplying bubble water to the reaction space 1S in a direction that deviates from the central axis CL of the reaction space 1S.

The exhaust unit A2 is configured to discharge gas generated by the oxidation reaction in the reaction space 1S from an upper region of the reaction space 1S through the exhaust port 3. The exhaust unit A2 includes an exhaust pipe 10 and an exhaust flow controller 11. The inlet of the exhaust pipe 10 is connected to the upper end of the reaction space 1S. That is, the inlet of the exhaust pipe 10 is connected to the exhaust port 3. The exhaust flow controller 11 controls the amount of gas discharged through the exhaust pipe 10. Because the exhaust flow controller 11 adjusts the exhaust flow through the exhaust pipe 10, the pressure in the reaction space 1S may be maintained at a desired level.

The exhaust flow controller 11 may be provided on the exhaust pipe 10 as a unit for opening and closing the flow path of the exhaust pipe 10, and may be configured to control the opening and closing operation using pneumatic pressure or electric power. For example, the exhaust flow controller 11 may be a valve such as a globe valve.

The drain unit A3 is configured to discharge the treated water that has completed the reaction with the oxidizing agent in the reaction space 1S from a lower region of the reaction space 1S through the lower discharge port 18. The drain unit A3 includes a drain pipe 8 and a drain flow controller 9. The inlet of the drain pipe 8 is connected to the center of the lower end of the reaction space 1S so as to be positioned on the central axis CL of the reaction space 1S. That is, the inlet of the drain pipe 8 is connected to the lower discharge port 18. The drain flow controller 9 controls the amount of treated water discharged through the drain pipe 8. Because the drain flow controller 9 adjusts the drain flow through the drain pipe 8, the water level in the reaction space 1S may be maintained at a desired height.

The drain flow controller 9 may be provided on the drain pipe 8 as a unit for opening and closing the flow path of the drain pipe 8, and may be configured to control the opening and closing operation using pneumatic pressure or electric power. For example, the drain flow controller 9 may be a valve such as a globe valve.

The return unit A4 includes a circulation water transfer pipe 4 branching from the drain pipe 8 to return the treated water introduced into the drain pipe 8 to the bubble water supply unit A1 and an upstream pump 6 functioning as a return power supply unit for providing power required to return the treated water through the circulation water transfer pipe 4. The circulation water transfer pipe 4 may correspond to the water inlet pipe 40 of the fine-bubble water generating device described above. The inlet of the circulation water transfer pipe 4 is connected to the drain pipe 8. Accordingly, a portion (upstream section) of the drain pipe 8 serves as a common drain pipe 8b through which both circulation water and treated water flow. The treated water that has passed through the common drain pipe 8b is discharged through a drain port 2 formed between the upstream section (common drain pipe 8b) and the downstream section of the drain pipe 8. The outlet of the circulation water transfer pipe 4 is connected to the bubble water supply pipe 5 to transfer the treated water to the bubble water supply pipe 5. According to the return unit A4, the circulation water transfer pipe 4 and the bubble water supply pipe 5 provide a circulation path (circulation pipeline) for returning the treated water discharged the reaction space 1S to the drain pipe 8 back to the reaction space 1S, and the circulation water transfer pipe 4, the bubble water supply pipe 5, and the upstream pump 6 constitute a circulation system for the treated water.

The wet oxidation reaction apparatus according to the first embodiment of the present disclosure further includes a downstream pump 7 functioning as a mixing unit for mixing the raw water and the oxidizing agent or for mixing the raw water, the oxidizing agent, and the treated water. The downstream pump 7 is provided in a downstream section of the bubble water supply pipe 5, and the raw water supply pipe 16, the gaseous oxygen supply pipe 15, and the circulation water transfer pipe 4 are connected to an upstream section of the bubble water supply pipe 5.

The upstream pump 6 is provided on the circulation water transfer pipe 4. The upstream pump 6 may be a pump including an electric motor and a rotary blade configured to be rotated by the electric motor. The downstream pump 7 is provided on the bubble water supply pipe 5. The downstream pump 7 may include an inline mixer including a cylindrical casing and a helical rotor inserted in the casing. Alternatively, the downstream pump 7 may include a friction pump in which minimal cavitation occurs even when gas is introduced thereinto. The friction pump may perform both the function of the upstream pump 6 (pumping operation) and the function of the downstream pump 7 (mixing operation). Therefore, when the friction pump is employed as the downstream pump 7, the wet oxidation reaction apparatus according to the first embodiment of the present disclosure may have a configuration excluding the upstream pump 6.

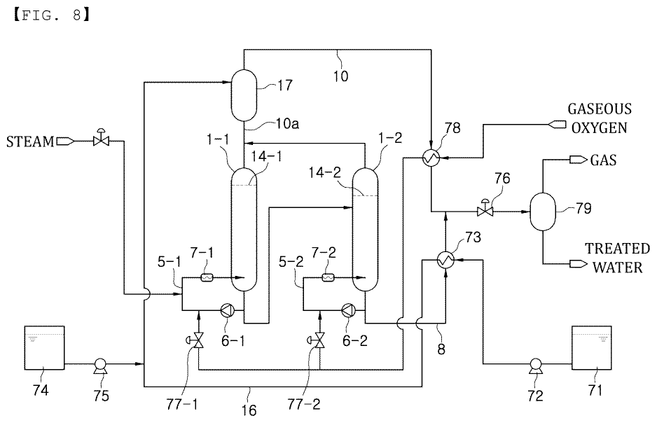

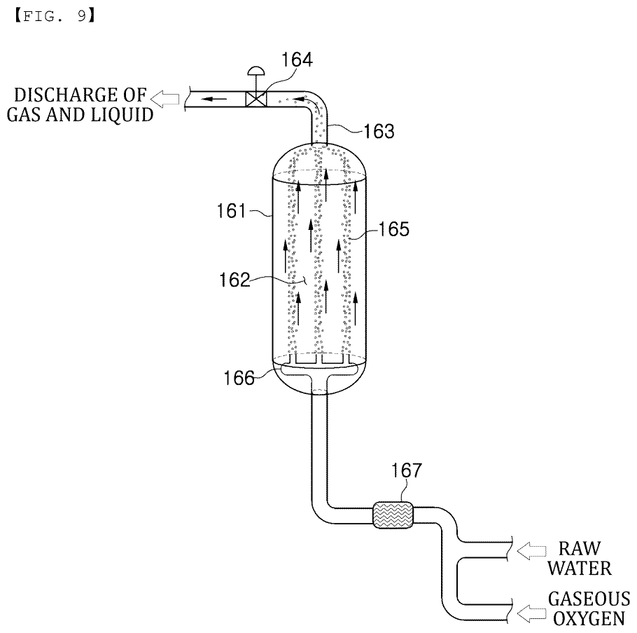

Meanwhile, the raw water supply pipe 16 may constitute a raw water supply unit. Referring to FIG. 8, when a packed tower 17 is mounted on the exhaust pipe 10 and the raw water supply pipe 16 is connected to an upper portion of the packed tower 17 to supply raw water thereto, the raw water passing through the packed tower 17 may absorb heat of the gas discharged after completion of the reaction, thereby improving thermal efficiency. In some cases, the raw water supply pipe 16 may be directly connected to the reaction vessel 1 at an arbitrary position.

The wet oxidation reaction apparatus according to the first embodiment of the present disclosure configured as described above may operate as follows.

The raw water (containing a reducing substance) from the raw water supply pipe 16 and the oxidizing agent (including gaseous oxygen) from the gas supply pipe 15, which are connected to the upstream section of the bubble water supply pipe 5, are uniformly mixed with each other by the downstream pump 7 on the bubble water supply pipe 5, and are supplied to the reaction space 1S in the form of bubble water in which bubbles are dispersed. Because the outlet of the bubble water supply pipe 5 is connected to the periphery of the reaction space 1S so as to deviate from the central axis CL of the reaction space 1S and the reaction space 1S is formed to have a circular cross-section, the supplied bubble water generates a swirling flow in a peripheral region rather than in a central region of the reaction space 1S. The supplied bubble water, having a reduced specific gravity due to the bubbles included therein, is pushed by subsequently supplied bubble water, and thus forms an upward swirling flow 12, which rises while swirling.

When the upward swirling flow 12 reaches a water surface 14, the water level of which is controlled by the drain flow controller 9, the upward swirling flow 12 loses the bubbles, and the specific gravity thereof increases. Thus, the upward swirling flow 12 is converted into a downward swirling flow 13, which descends while swirling in the central region of the reaction space 1S. The downward swirling flow 13 is directed toward the lower region of the reaction space 1S, and is then discharged from the reaction space 1S through the lower discharge port 18.

Through the above process, the raw water is discharged as treated water according to oxidation reaction between the reducing substance and the gaseous oxygen.

When the upstream pump 6 operates, a portion of the treated water discharged along the drain pipe 8 flows into the circulation water transfer pipe 4, is introduced into the bubble water supply pipe 5, is mixed with the bubble water by the downstream pump 7, and is then supplied to the reaction space 1S (circulation of treated water).

Although not shown in FIGS. 2 and 3, when the raw water is supplied, a fluidized oxidation reaction catalyst may be mixed into the raw water to promote reactivity.

Meanwhile, gases generated by the oxidation reaction in the reaction space IS, such as carbon dioxide and water vapor (which may include unreacted residual gaseous oxygen), may be discharged from the reaction space 1S through the exhaust port 3. In order to maintain the pressure (internal pressure) in the reaction vessel 1 at a higher pressure than atmospheric pressure, the exhaust flow may be adjusted by the exhaust flow controller 11. Accordingly, the internal temperature of the reaction vessel 1 may be maintained at a high temperature (100 °C or higher).

In addition, it is advantageous to maintain the height of the water surface 14 in the reaction vessel 1 at the highest possible level within a technically controllable range to make efficient use of the reaction space 1S. However, considering safety, it is advantageous that the height of the water surface 14 be in the range of 80% to 90% of the overall height of the reaction space 1S.

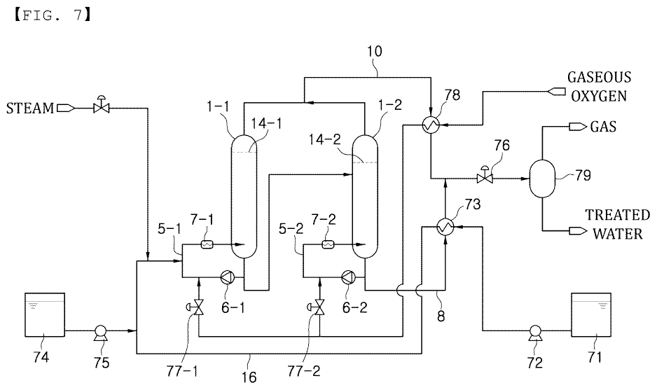

In addition, the drain pipe 8 and the exhaust pipe 10 may be combined into a single conduit, and a single fluid discharge control unit, such as an automatic control valve (see reference numeral 76 in FIGS. 7 and 8), may be provided on the combined conduit to simultaneously discharge the treated water and the gas. In this case, the mounting position of the fluid discharge control unit may be set to a predetermined height corresponding to the middle portion of the reaction space 1S, so that the water level in the reaction space 1S is automatically adjusted by the hydraulic pressure difference between the water level and the outlet of the fluid discharge control unit, which serves as a discharge unit for both the treated water and the gas.

For reference, it is advantageous that the raw water and the oxidizing agent to be supplied to the reaction space 1S be preheated through a heating unit. However, illustration of the heating unit is omitted in FIGS. 2 and 3.

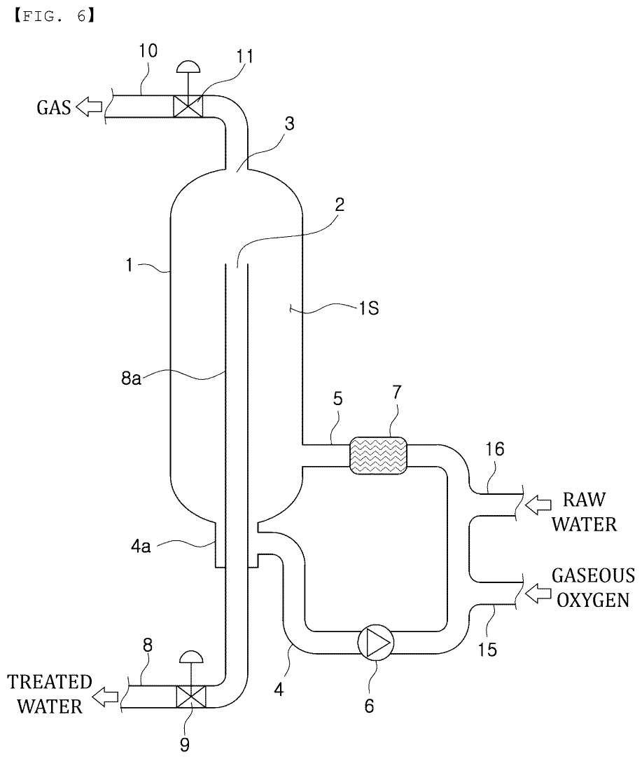

The configuration and operation of a wet oxidation reaction apparatus according to a second embodiment of the present disclosure are conceptually shown in a front cross-sectional view in FIG. 6.

As shown in FIG. 6, the wet oxidation reaction apparatus according to the second embodiment of the present disclosure differs from the wet oxidation reaction apparatus according to the first embodiment of the present disclosure described above in that the drain unit (see reference numeral A3 in FIG. 2) and the return unit (see reference numeral A4 in FIG. 2) are configured differently, while all other components remain the same.

In the drain unit of the wet oxidation reaction apparatus according to the second embodiment of the present disclosure, the drain pipe 8 includes an extended drain pipe 8a, which is elongated upward in the reaction space 1S such that the drain port 2 serving as an inlet of the extended drain pipe 8a is positioned at a preset height along the central axis (see reference number CL in FIG. 2) of the reaction space 1S. The extended drain pipe 8a is oriented vertically in the reaction space 1S. The height (set height) of the extended drain pipe 8a may be in the range of 70% to 90% of the overall height of the reaction space 1S. Accordingly, the drain port 2 formed in the upper end of the extended drain pipe 8a may be disposed at a height in the range of 70% to 90% of the overall height of the reaction space 1S.

The return unit of the wet oxidation reaction apparatus according to the second embodiment of the present disclosure further includes a circulation water discharge pipe 4a. The circulation water discharge pipe 4a is disposed outside the drain pipe 8 to form a double-pipe configuration with the drain pipe 8. The inlet formed in the upper end of the circulation water discharge pipe 4a is connected to the center of the lower end of the reaction space 1S so as to be concentric with the drain port 2 serving as an inlet of the drain pipe 8. The outlet of the circulation water discharge pipe 4a is formed on the periphery of the circulation water discharge pipe 4a. The circulation water transfer pipe 4 is connected to the outlet of the circulation water discharge pipe 4a. In the return unit, the inlet of the circulation water transfer pipe 4 may be connected to the circulation water discharge pipe 4a in a tangential direction.

One of the operational differences between the wet oxidation reaction apparatus according to the second embodiment of the present disclosure and the wet oxidation reaction apparatus according to the first embodiment of the present disclosure is that the extended drain pipe 8a (which may have a linear structure) elongated along and disposed on the central axis of the reaction space 1S is capable of inducing stable and smooth flows of the raw water and the treated water (i.e., upward swirling flow (see reference numeral 12 in FIG. 3) and downward swirling flow (see reference numeral 13 in FIG. 3).

Another operational difference between the wet oxidation reaction apparatus according to the second embodiment of the present disclosure and the wet oxidation reaction apparatus according to the first embodiment of the present disclosure is that the treated water that has undergone the oxidation reaction is controlled to rise above the height of the extended drain pipe 8a and to be discharged through the drain port 2 serving as the upper end of the extended drain pipe 8a. Due to such a difference, the reaction space 1S may be reliably secured by the height of the extended drain pipe 8a. In addition, a portion of the treated water may be circulated via the circulation water discharge pipe 4a and the circulation water transfer pipe 4.

In the wet oxidation reaction apparatus according to the second embodiment of the present disclosure described above, the drain pipe 8 and the exhaust pipe 10 may be combined into a single conduit, and a single fluid discharge control unit, such as an automatic control valve (see reference numeral 76 in FIGS. 7 and 8), may be provided on the combined conduit to simultaneously discharge the treated water and the gas. In this case, the mounting position of the fluid discharge control unit may be set to a predetermined height corresponding to the middle portion of the reaction space 1S, so that the water level in the reaction space 1S is automatically adjusted by the hydraulic pressure difference between the water level and the outlet of the fluid discharge control unit, which serves as a discharge unit for both the treated water and the gas. In addition, application of the configuration in which the water level in the reaction space 1S is automatically adjusted provides an advantage in that the mounting position of the exhaust flow controller 11 is easily determined.

FIG. 7 is a process diagram showing an example of a facility including the wet oxidation reaction apparatus according to the embodiment of the present disclosure. As shown in FIG. 7, a plurality of wet oxidation reaction apparatuses according to the embodiment of the present disclosure may be combined to constitute a single facility. This will be described as follows.

First, raw water stored in a raw water storage unit 71 is supplied to an oxidation reaction process by a raw water supply pump 72 that constitutes a raw water supply unit. In the example shown in FIG. 7, a first reaction vessel 1-1 and a second reaction vessel 1-2 are provided as reaction vessels, and these two reaction vessels are connected to each other in series. The raw water may be preheated through a preheating heat exchanger 73 before being introduced into the reaction vessels. As a heat source for heat exchange, treated water that has undergone an oxidation reaction process may be used, or a separate heat source such as electrical heating, steam, or hot water may be used. A predetermined amount of fluidized catalyst may be added to the raw water, which is to be introduced into the reaction vessel, in order to promote the oxidation reaction. As the fluidized catalyst, an aqueous solution of at least one transition metal such as iron, copper, or manganese in an ionic state or a coordination compound state may be used, or a chemical pH control agent such as sulfuric acid or caustic soda may be used. In the case of a transition metal, the usage ratio relative to the raw water may be about 1 to 1,000 parts per million (ppm) based on the pure metal component. In FIG. 7, reference numeral 74 denotes a fluidized catalyst storage unit, and reference numeral 75 denotes a fluidized catalyst supply pump.

The raw water preheated and with the catalyst added thereto in this way is transferred to the first reaction vessel 1-1 through a bubble water supply pipe 5-1. In this case, the raw water is mixed with gaseous oxygen and treated water, introduced via a first oxidizing agent flow controller 77-1 and a first return power supply unit 6-1, by a first mixing unit 7-1, and thus becomes bubble water. While moving in the form of an upward swirling flow (see reference numeral 12 in FIG. 2) within the first reaction vessel 1-1, the bubble water reacts with the gaseous oxygen to become treated water. After forming a downward swirling flow (see reference numeral 13 in FIG. 2), a portion of the treated water is circulated by the first return power supply unit 6-1 to undergo an additional oxidation reaction, and another portion thereof flows to the second reaction vessel 1-2.

The treated water introduced into the second reaction vessel 1-2 forms an upward swirling flow and a downward swirling flow within the second reaction vessel 1-2. A portion of the treated water is circulated by a second return power supply unit 6-2 and is mixed with gaseous oxygen, supplied through the first oxidizing agent flow controller 77-1, by a first mixing unit 7-2. A portion of the treated water that has undergone the oxidation reaction in the second reaction vessel 1-2 is discharged via a fluid discharge control unit 76, and a predetermined amount of treated water is finally discharged outside via a pressure-reducing tank 79.

Meanwhile, an unreacted gas, such as gaseous oxygen supplied in excess to the first and second reaction vessels 1-1 and 1-2 or nitrogen mixed with the gaseous oxygen, and a gas generated as a result of the oxidation reaction, such as carbon dioxide or water vapor, are discharged outside through the integrated exhaust pipe 10 and the fluid discharge control unit 76. During this process, the discharged gas may have oxidation reaction heat recovered through a gas-phase heat exchanger 78 and may be used to preheat the gaseous oxygen to be supplied to the first reaction vessel 1-1. In order to allow the fluid discharge control unit 76 to simultaneously discharge the gas and the treated water, the fluid discharge control unit 76 needs to be disposed at a predetermined position lower than water surfaces 14-1 and 14-2 in the first and second reaction vessels 1-1 and 1-2, so that the treated water may maintain a sequential flow through the first reaction vessel 1-1, the second reaction vessel 1-2, and the fluid discharge control 76 due to a hydraulic head difference. This may be achieved, for example, by lowering the water levels in the reaction vessels or by placing the reaction vessels at lower positions. As in the embodiment shown in FIG. 6, when the wet oxidation reaction apparatus includes the extended drain pipe 8a that is elongated upward and has an upper end serving as the drain port 2, the fluid discharge control unit 76 may be placed at a lower height without adversely affecting the operation of the apparatus.

In FIG. 7, the outlet of the pipe through which the treated water having undergone the reaction in the first reaction vessel 1-1 is transferred to the second reaction vessel 1-2 is shown as being directly connected to the second reaction vessel 1-2. The temperature for wet oxidation treatment using gaseous oxygen may vary depending on the type of reducing substances present in the raw water. Typically, it is advantageous that the temperature for wet oxidation treatment using gaseous oxygen be in the range of 150 °C to 280 °C in terms of treatment rate or operational management. In addition, although not shown in FIG. 7, a heat exchanger may be mounted on the pipe for transferring the gas and the treated water discharged from the reaction vessels after the oxidation reaction, thereby recovering heat from the discharged gas and treated water and utilizing the heat. Furthermore, a generator including a turbine may be mounted on the pipe for transferring the gas and the treated water discharged from the vessels, thereby producing electric power using the discharge pressure of the gas and the treated water. In addition, a separate purification unit may be mounted on the exhaust pipe 10 to remove volatile organic materials remaining in the gas.

FIG. 8 is a process diagram showing another example of the facility including the wet oxidation reaction apparatus according to the embodiment of the present disclosure. As shown in FIG. 8, unlike the above-described example of the facility, the other example of the facility is configured such that a packed tower 17 is mounted on the exhaust pipe 10, and the raw water supply pipe 16 is connected to the packed tower 17, thereby absorbing heat of the gas discharged from the reaction vessels 1-1 and 1-2 after the oxidation reaction. For reference, in the pipe denoted by reference numeral 10a in FIG. 8, inflow raw water flowing downward from above and gas rising upward from below flow in opposite directions. To this end, the pipe denoted by reference numeral 10a may be designed to have a relatively large diameter.

While the present disclosure has been described above, the present disclosure is not limited to the disclosed embodiments and the accompanying drawings, and those skilled in the art may variously modify the present disclosure without departing from the technical spirit of the present disclosure. In addition, the technical features described in the embodiments of the present disclosure may be independently carried out, or two or more technical features may be combined.

1. A fine-bubble water generating device for water treatment, the device comprising:
a first pipe comprising a water inlet pipe disposed at an upstream section of the first pipe to receive water for generation of bubble water and a bubble water supply pipe disposed at a downstream section of the first pipe and connected to the water inlet pipe;
a second pipe connected to the first pipe between the water inlet pipe and the bubble water supply pipe to supply gas for generation of the bubble water to the first pipe; and
upstream and downstream pumps provided on the first pipe, the upstream pump being disposed on an upstream side of the second pipe, the downstream pump being disposed on a downstream side of the second pipe.

2. The device according to claim 1, further comprising a flow rate control unit provided on the second pipe.

3. A wet oxidation reaction apparatus for water treatment, the apparatus comprising:
a reaction vessel extending vertically, the reaction vessel having a reaction space defined therein so as to have a circular cross-section;
a raw water supply unit configured to supply raw water containing a reducing substance to the reaction space;
a bubble water supply unit configured to mix water withdrawn from the reaction space with gaseous oxygen to generate bubble water and to supply the generated bubble water to the reaction space in a direction deviating from a central axis of the reaction space to generate a swirling flow within the reaction space;
an exhaust unit configured to discharge gas generated during reaction between water of the bubble water and gaseous oxygen upward from the reaction space;
a drain unit configured to discharge water having undergone the reaction downward; and
a return unit configured to withdraw water from the reaction space and to transfer the water withdrawn from the reaction space back to the bubble water supply unit.

4. The apparatus according to claim 3, wherein the drain unit comprises a drain pipe having a common drain pipe connected to the reaction vessel, the common drain pipe corresponding to an upstream section of the drain pipe, and
wherein the return unit comprises a circulation water transfer pipe branching from the common drain pipe to return water to the bubble water supply unit.

5. The apparatus according to claim 3, wherein the drain unit comprises a drain pipe connected to the reaction vessel,
wherein the drain pipe has an extended drain pipe corresponding to an upstream section of the drain pipe and elongated upward such that a drain port serving as an inlet of the extended drain pipe is positioned at a preset height along a central axis of the reaction space, and
wherein water is discharged through the drain port formed in an upper end of the extended drain pipe.

6. The apparatus according to claim 3, wherein the drain unit comprises a drain pipe connected to the reaction vessel, and
wherein the return unit comprises:
a circulation water discharge pipe disposed outside the drain pipe to form a double-pipe configuration with the drain pipe and connected to a lower end of the reaction space so as to be concentric with the drain pipe; and
a circulation water transfer pipe connected to a periphery of the circulation water discharge pipe to return water introduced from the circulation water discharge pipe to the bubble water supply unit.

7. The apparatus according to claim 4, wherein the bubble water supply unit comprises a bubble water supply pipe having an outlet connected to a periphery of the reaction space in a direction deviating from the central axis,
wherein the circulation water transfer pipe is connected to the bubble water supply pipe to transfer water to the bubble water supply pipe, and
wherein treated water from the reaction space returns to the reaction space via a circulation path formed by the bubble water supply pipe and the circulation water transfer pipe.

8. The apparatus according to claim 7, further comprising a mixing unit configured to mix water with gaseous oxygen in the bubble water supply pipe,
wherein the mixing unit comprises a pump configured to perform a mixing operation and a pumping operation using a rotary blade.

9. The apparatus according to claim 6, wherein the bubble water supply unit comprises a bubble water supply pipe having an outlet connected to a periphery of the reaction space in a direction deviating from the central axis,
wherein the circulation water transfer pipe is connected to the bubble water supply pipe to transfer water to the bubble water supply pipe, and
wherein treated water from the reaction space returns to the reaction space via a circulation path formed by the bubble water supply pipe and the circulation water transfer pipe.

10. The apparatus according to claim 9, further comprising a mixing unit configured to mix water with gaseous oxygen in the bubble water supply pipe,
wherein the mixing unit comprises a pump configured to perform a mixing operation and a pumping operation using a rotary blade.
